(19) United States
(12) Patent Application Publication
(10) Pub. No.: US 2009/0258702 A1
(43) Pub. Date: Oct. 15, 2009

(54) MUSIC VIDEO GAME WITH OPEN NOTE

(76) Inventors: Alan Flores, Woodland Hills, CA (US); Paul Robinson, Woodland Hills, CA (US); John Devecka, Budd Lake, NJ (US)

Correspondence Address: CHRISTIE, PARKER & HALE, LLP, PO BOX 7068, PASADENA, CA, 91109-7068, US

(21) Appl. No.: 12/103,663

(22) Filed: Apr. 15, 2008

(51) Int. Cl. A63F 9/24; A63F 13/08; A63F 13/00

(52) U.S. Cl. 463/35; 463/31; 463/37

(57) ABSTRACT

A music video game provides an open note executable on a guitar shaped video game controller. In some embodiments, an open note may be performed on an existing guitar shaped video game controller by activating a strum input on the video game controller without activating any of a plurality of fret inputs on the video game controller. The open note may serve as an equivalent to an open chord played on a real guitar. In some embodiments, an instructive cue is provided to inform users when to perform an open note in the context of the music video game.

### BACKGROUND OF THE INVENTION

The present invention relates generally to video games, and more particularly to a guitar related music rhythm video game including an open note feature.

Video games provide a source of entertainment and enjoyment for many. Video games create a simulated environment where players may experience and participate in various types of activities they would not otherwise be able to experience. For example, music based video games may allow users to experience the joy of playing musical instruments, while also presenting such users challenging game situations. By playing a music based video game with a guitar shaped video game controller, video game players may experience, to a certain extent, what it would feel like to play a real guitar, without the years of training or practice generally associated with learning how to play a real guitar.

While playing a video game equivalent of a real instrument may not prove as challenging as playing the real instrument itself, successfully operating the video game equivalent may provide its own set of challenges. Unfortunately, some users may be able to overcome those challenges, whether with relative ease or ultimately after expending great time and effort, and desire further challenges. In addition, those who have developed skill with musical instruments may find the game playing experience incomplete.

### BRIEF SUMMARY OF THE INVENTION

The present invention provides a music related video game with an open note feature. In one aspect the invention provides a method for processing an unfretted input in a music rhythm video game, comprising: presenting an instructive cue, the instructive cue instructing a user of a video game controller to generate input signals using a video game controller associated with an unfretted input; receiving a strum input signal generated from the video game controller; receiving an indication that no fret buttons of a plurality of fret buttons on the video game controller were activated when the strum input signal was generated; and determining compliance with the instructive cue if the strum input signal and indication are received within a predetermined window of time after the instructive cue is presented. In another aspect the invention provides A system for providing game play instructions to a user for a music rhythm video game, comprising: a display; at least one video game controller including a strum input and a plurality of fret buttons; and a processor configured by program instructions to generate a visual user interface including game play instructions, the visual user interface comprising: a scrolling music track; a plurality of symbols on the scrolling music track, the symbols providing instructive cues instructing the user to activate the strum input while depressing a combination of fret buttons of the plurality of fret buttons; and a further symbol providing further instructive cues instructing the user to activate the strum input without depressing any of the plurality of fret buttons.

These and other aspects of the invention are more fully comprehended on review of this disclosure.

### BRIEF DESCRIPTION OF THE DRAWINGS

FIG. 1 is a video game system in accordance with aspects of the invention;

FIG. 2 is a block diagram of a processing unit in a video game console in accordance with aspects of the invention;

FIG. 3 is a flow diagram of a process of generating a note on a guitar shaped video game controller in accordance with aspects of the invention;

FIG. 4 is a flow diagram of a process of determining compliance with an open note cue in accordance with aspects of the invention; and

FIG. 5 is a screen shot of a music rhythm video game during video game play including an open note cue in accordance with aspects of the invention.

### DETAILED DESCRIPTION

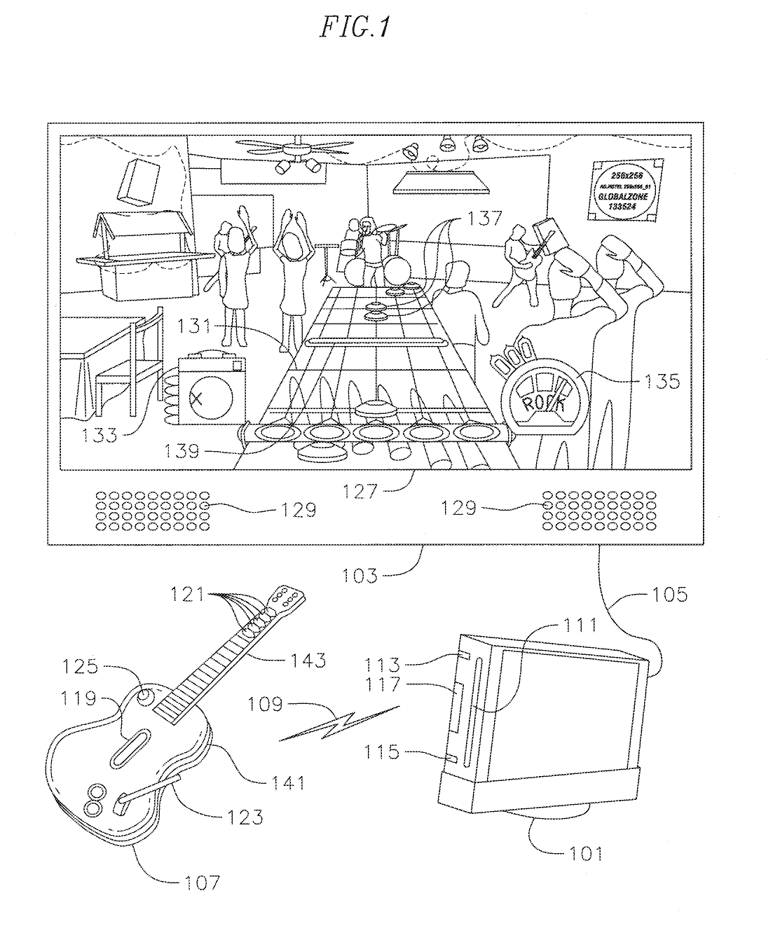

FIG. 1 is a video game system in accordance with aspects of the invention. The video game system of FIG. 1 includes a video game console 101 processing an inserted music rhythm video game. The video game console is connected to a display unit 103 via an audio-video cable 105, sending audio and video output signals pertaining to video game play to the display unit through the audio-video cable. The video game console is also in communication with at least one user operated video game controller 107. In FIG. 1, the communication between the video game console and the video game controller is facilitated through a wireless connection 109, but in other embodiments, a wired connection may exist between the video game controller and the video game console.

The video game console includes internal circuitry for processing video games. The internal circuitry may include, for example, at least one processor, memory, and a plurality of different interfacing devices. Among the interfacing devices is an external memory interface 111, configured to receive an external memory source including video game instructions for a particular video game, for example, a video game CD-ROM. The video game console of FIG. 1 may also include, for example, a wireless communication interface for communicating with associated video game controllers, and for example, audio and video input/output ports for connecting the video game console to the display unit. The video game console may also include external user interface devices, for example, a power button 113, an eject button 115, and a peripheral port 117 for users to connect additional memory sources or various peripheral devices.

The video game console in FIG. 1 is processing a music rhythm video game. The music rhythm video game provides instructive cues, the instructive cues directing a user to manipulate the video game controller in distinct ways to match the cues. In FIG. 1, the music rhythm video game simulate playing a guitar, for example, in a band. The video game console processes video game instructions from the external memory source, and generates user instructive cues, which may be considered a series of notes or combination of notes, for users to match on the video game controller. The instructive cues, generally provided in the context of or forming a track of a song, challenge users to play the right “notes” on the video game controller at the right times.

The video game controller in FIG. 1 is a guitar shaped video game controller. The guitar shaped video game controller includes a body 141 and a neck 143 extending from the body. A strum bar input 119 is located on the guitar body, and a plurality of fret button inputs is located on the guitar neck. Various other inputs, for example, a tremolo arm assembly 123 and an analog control stick 125 are also located on the guitar body. The video game controller also includes internal circuitry including control circuitry, which processes user manipulations of, for example, the strum bar and fret buttons on the video game controller, and generates signals based on the user manipulations, and the signals may be considered input signals as they are generally input to a video game console or a processor executing program instructions for a video game.

In operation, the plurality of fret buttons may be considered as substitutes for strings on a real guitar, with depression of different fret combinations possibly simulating chord fingering patterns on guitar strings. The strum bar may be displaceable in a rotational or translational manner, for example in what may be considered in an up or down direction depending on position of the video game controller, to simulate a strumming action performed on guitar strings to produce sounds. The combination of a strum displacement with a particular fret fingering generates a simulated sound in the music rhythm video game based on the fret fingering. In embodiments of the invention, a simulated sound is also generated for an open note, for example, if a strum bar displacement is detected and none of the fret buttons are depressed.

The video game console receives the input signals from the video game controller, and processes the video game action based, in part, on the received input signals. In some embodiments of the music rhythm video game, the processor of the video game console determines user compliance with the instructive cues or notes displayed for a song. The processor generates musical audio output information and video output information in accordance with the received input signals. For example, a note or a portion of the song may be played if the user complies with an instructive cue, or a sound inappropriate for the song may be played if the user does not comply with the instructive cue. The processor may also adjust video game status information, for example, user scores and power meters, based on the input signals received from the video game controller.

The video game console sends processed audio and video output information to the display unit via the audio-video cable, although wireless communication circuitry may be used in some embodiments. In FIG. 1, the display is a television including a display screen 127 and a pair of audio speakers 129. The display shows a screen shot of a user interface in certain embodiments of the invention. The screen shot includes a music track 131 with instructive cues, a user score display 133, and a power meter display 135. The music track with the instructive cues instructs a user to play a particular note or chord on the guitar shaped video game controller by manipulating the various inputs on the guitar shaped video game controller. In embodiments of the invention, and as is illustrated in the screen shot of FIG. 1, the instructive cues may include colored gems, for example, colored gems 137, representing the different fret buttons, and a white horizontal bar 139, indicating an open note, where the strum is displaced with no fret buttons depressed.

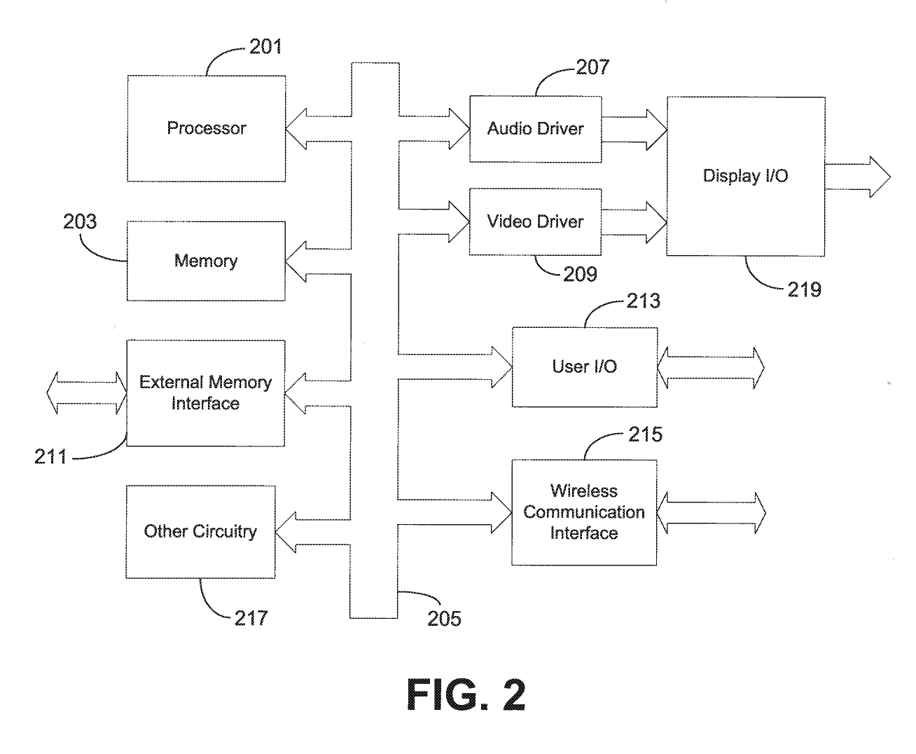

FIG. 2 is a block diagram of a processing unit in a video game console in accordance with aspects of the invention. In some embodiments, the processing unit includes a processor 201 connected to and communicating with memory 203 via a bus 205. The bus also connects other components to the processor, for example, an audio driver 207 and a video driver 209, an external memory interface 211, a user input/output port 213, a wireless communication interface 215, and other circuitry 217. The audio and video drivers may be further connected to a display input/output port 219, or alternatively, separate audio and video input output ports.

The processor facilitates video game play by executing video game program instructions. Software instructions associated with a particular video game, for example, embodiments of a music rhythm video game as described herein, may be found on an inserted external memory source holding video game program instructions, for example, a video game CD-ROM. Video game program instructions may include, for example, video game configuration settings, game play instructions, user input signal processing instructions, and audio and video output generation instructions. The processor may process the video game program instructions based on program instructions for the particular video game console, which is typically found in the video game console's memory. Any processed information may also be stored by the processor into the memory.

As seen in FIG. 1, at least one video game controller is communicating with the video game console to affect video game play. The video game controllers may either communicate with the processor of the video game console via the user input/output port, generally through a wired connection, or alternatively via the wireless communication interface, which in most embodiments is one of a variety of different wireless transceivers. The video game controllers send user generated input signals to the processing unit, and video game play is personalized based on the user generated input signals.

The processor processes the video game information, program information, and user input signals, and determines video game action based on the different sources of information. The processor may generate audio and video generation information associated with video game action, and send the information to audio and video drivers, respectively. The audio driver may process the audio generation information to create audio outputs, and the video driver may likewise process the video generation information to create video outputs. In the embodiment of FIG. 2, the audio and video outputs are sent through a display input/output port to a display unit connected to the port. The display unit presents the outputs to users of the video game, thereby providing a source of continuous video game feedback to the users.

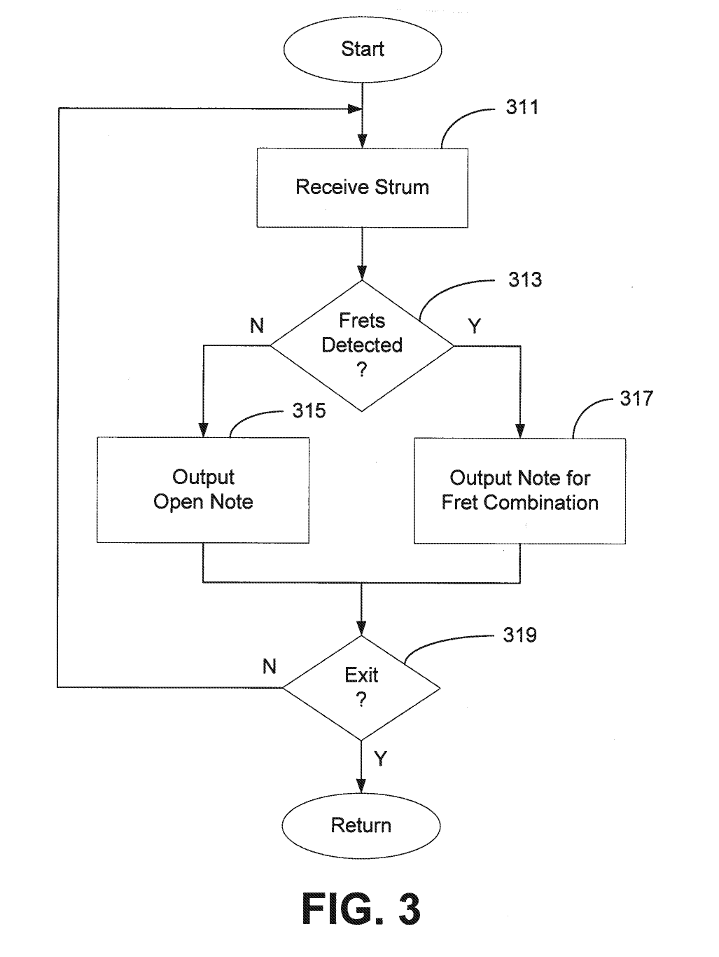

FIG. 3 is a flow diagram of a process of generating a note or other sound or sounds based on a guitar shaped video game controller generated signals in accordance with aspects of the invention. The process may be performed, for example, by a video game console or a processor configured by program instructions. In block 311, the process receives a strum input from a video game controller. A strum input may be considered to simulate the playing of a note or a chord on a guitar through strumming of the guitar strings. In most embodiments of the invention, a strum input is generated through a generally lateral displacement, which may be considered an upward or downward displacement, of the strum bar of the video game controller discussed in FIG. 1. A strum input signal is generated by the video game controller, and is sent by control circuitry in the video game controller to the video game console.

In block 313, the process determines if there are any depressed fret button inputs. In most embodiments, when a strum displacement is detected by the video game controller and a strum input is generated, the video game controller also generates a fret input signal indicating depressed fret buttons on the video game controller at the time of the strum displacement. In these embodiments, the fret input signal may be sent to the video game console together with the strum input signal. In other embodiments, the processor of the video game console may detect a strum input from the video game controller. Upon a strum input detection, the processor may request information regarding the state of the fret buttons from the video game controller, or the processor may have already received such information. If at the time of the strum displacement, there are no fret buttons depressed, the process proceeds to block 315. If, however, at least one fret button is depressed when a strum input is detected, the process proceeds to block 317.

In block 315, the process generates and outputs an open note. The open note may be considered a non-fretted note, or in some embodiments a non-fretted chord. In some embodiments an open note may be an E note of a guitar. In other embodiments, for example where a user may be able to configure mapping of video game controller inputs with sounds, the open note may correspond to various different note outputs depending on default or applied configuration settings.

In block 317, the process generates and outputs an output note based on the combination of depressed fret buttons. In most embodiments, each fret button and combination of fret buttons is mapped to a different output note in the context of the video game. The output note mappings may be stored with and retrieved from, for example, memory or the video game instructions found on the external memory source.

In block 319, the process determines whether to remain in note generation, or to exit. If the process decides to remain in note generation, the process returns to block 311 to await a subsequent strum input signal. If the process decides to exit note generation, the process returns.

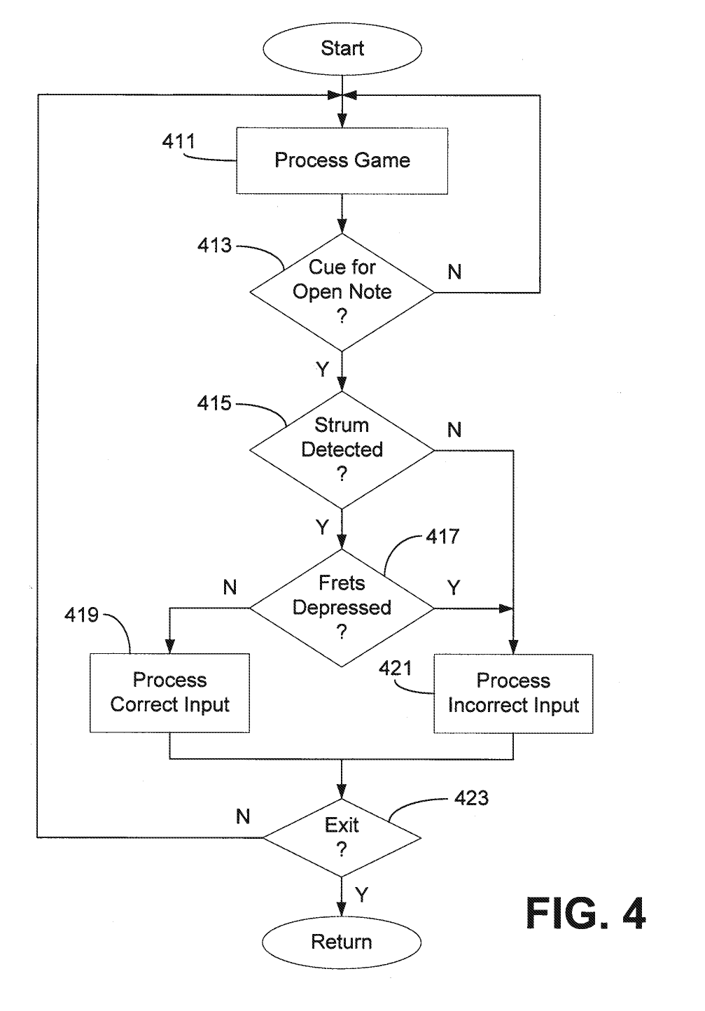

FIG. 4 is a flow diagram of a process of determining compliance with an open note cue in accordance with aspects of the invention. As with the process of FIG. 3, the process is performed in some embodiments by the video game console of FIG. 1 or the processor of FIG. 2. In some embodiments, the process is performed when a user of a video game is instructed to play an open note on a guitar shaped video game controller. In some embodiments, the process is performed when an open note cue, for example, the white horizontal bar as illustrated in the screen shot of FIG. 1, appears, or appears in a particular location, on a user interface associated with video game play. In various other embodiments, similar visual representations of open notes may be generated by the processor of the video game console to indicate to a user to play an open note on the video game controller. For example, instructive cues for performing a strum with particular fret buttons depressed may be provided by scrolling graphical symbols or gems, with graphical symbols in a particular column (or particular shape or color) indicating depression of corresponding fret buttons. Similarly, a further column (or shape or color) may provide an instructive cue to perform a strum with no fret buttons depressed. Thus, for example, a gem or a graphical symbol at a predefined location on a far left of a scrolling note track may instruct a strum with no fret buttons depressed.

In block 411, the process processes video game instructions for video game play. The process generally involves a processor of a video game console processing video game instructions, and executing other commands associated with video game play, for example, receiving and processing user input signals and generating video and audio signals to send to a video display. In embodiments involving music rhythm video games, the video signals generated by the processor may include, for example, game play instructions in the form of instructive cues for the user to play on, for example, a guitar shaped video game controller. The instructive cues may include information on different inputs to activate on the video game controller, as well as correct times to activate each of the different inputs.

In block 413, the process determines whether a cue for an open note has been detected. For example, in the embodiment of the music rhythm video game as has been described, a cue for an open note may indicate a portion of the song where an open note audio output is desired. Alternatively, the open note may merely represent a note or some other sound or sequence of sounds, generally lower in pitch than other notes or sounds in a song. Moreover, at different times the open note may represent different sounds. In some embodiments, a cue for an open note may be represented visually to a user by a horizontal white bar, or a bar crossing locations generally used for multiple other instructive cues, as was seen in the embodiment illustrated in FIG. 1. In other embodiments, other visual cues, for example, an “OPEN” notation, a combination of uncolored gems, or some other instructive cue, may indicate to users when to play an open note on a guitar shaped video game controller. If the process determines that a cue for an open note has been presented, the process proceeds to block 415. If the process determines that a cue for an open note has not been presented, the process returns to block 411 for further video game processing. Note that in the flow diagram of FIG. 4, video game processing in block 411 may include detection and processing of cues for fretted notes to be played on the guitar shaped video game controller.

In block 415, the process determines whether a correctly timed strum input signal is detected. In embodiments of the invention, detection of a strum input signal indicates that the strum bar has been displaced or actuated on the guitar shaped video game controller. In block 415, the process determines whether the timing of the strum bar displacement on the guitar video game controller is correct. After a cue for an open note has been detected, a short window of time is generally allotted for detection of a strum input signal. A strum input signal detected within the window of time indicates correct timing of a note being played, and the process proceeds to block 417. If the strum input signal is detected outside the window of time, or if no strum input signal is detected, the process proceeds to block 421.

In block 417, the process determines whether any fret buttons were depressed at the time of the strum input signal detection. To correctly play an open note, no fret buttons are depressed at the time a strum input is generated on the guitar shaped video game controller. In block 417, the process processes additional input signals from the guitar shaped video game controller to see whether the open note was correctly played. If no fret buttons were depressed at the time of the strum, the process proceeds to block 419. If, however, at least one of the fret buttons was depressed at the time of the strum, the process proceeds to block 421.

In block 419, the process processes a correct input signal. A correct input signal in the process of FIG. 4 includes correct detection of an open note played on the guitar shaped video game controller, as well as correct timing of the open note detection. In most embodiments, processing of a correct input signal coincides with generation of audio and video outputs indicating that a correct input signal was received. An example of audio output generation may include audio feedback in the form of a note which fits into the context of the song being played, or other sounds in conformance with the song. Furthermore, a user score may be increased based on the correct input being detected, and/or a user power level may be maintained or raised based on the correct input.

In block 421, the process processes an incorrect input signal. An incorrect input signal may be processed when, for example, a strum input is not received when a cue for an open note is detected by the process, or for example, when the strum input is received outside of an allotted window of time for receipt of a correct strum input signal. An incorrect input signal may also be processed when, for example, the timing of a received strum input is accurate, but a note other than an open note was played on the guitar shaped video game controller, or in other words, at least one fret button was depressed at the time of the strum input. In embodiments of the invention, processing of an incorrect input signal may coincide with generation of audio and video outputs indicating that an incorrect input signal was received. In some embodiments, audio outputs generated may include, for example, random sounds that do not fit into the context of the song being played. In some embodiments, points may be deducted for an incorrect input signal, and/or a user power level may decreased.

In block 423, the process determines whether to exit. If the process decides to continue video game processing, the process returns to block 411 and continues processing the video game. If the process decides to exit, the process returns.

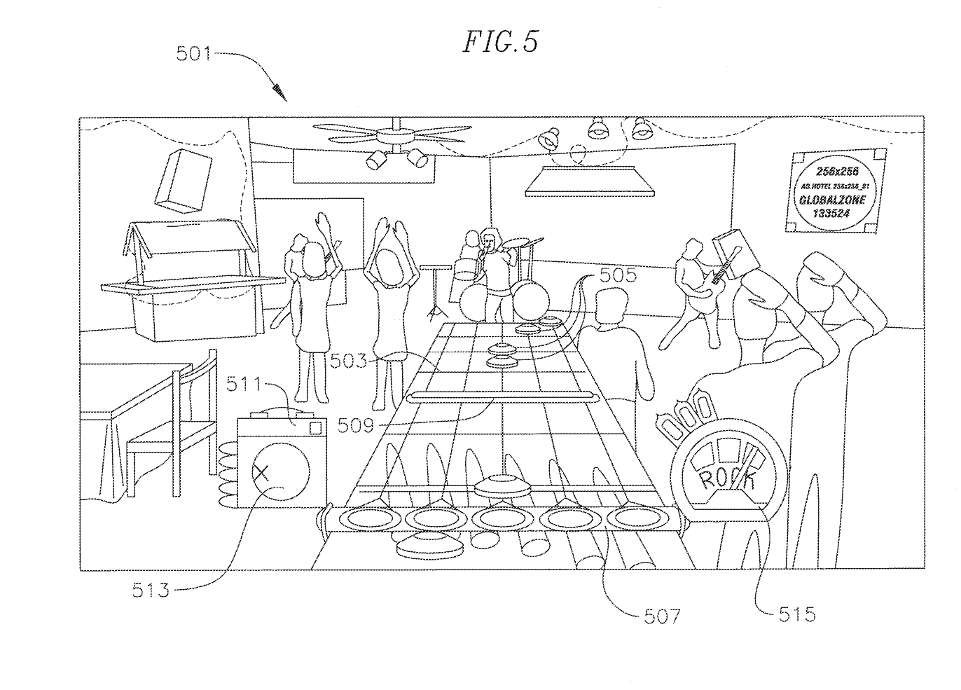

FIG. 5 is a screen shot of a music rhythm video game during video game play including an open note cue in accordance with aspects of the invention. For aesthetic purposes, the screen shot may provide a dynamic background 501 associated with music playing, for example, a music venue or a recording studio. In other embodiments with different video games, various types of backgrounds may be applied, depending on the application of the different video games.

The screen shot features a centrally located scrolling music track 503. The scrolling music track provides users with video game instructions, generally instructive cues as to how to play or manipulate a video game controller associated with video game play. In the context of a music rhythm video game with guitar shaped video game controllers, the instructive cues may include instructions on when to play a note on a video game controller, simulated by actuating a strum bar input, and the correct note to be played, simulated by depressing different fret button inputs at the time of the strum.

The scrolling music track scrolls from top to bottom, although in some embodiments the track may scroll in other directions. The music track is configured wider near the bottom and narrower near the top, giving users of the video game a perspective view, wherein it appears the music track is scrolling towards them. A plurality of colored gems appear on the music track, for example, colored gems 505. The colored gems correspond to different fret buttons to be depressed on the guitar shaped video game controller. The music track with colored gems scrolls towards a fixed horizontal bar 507 near the bottom of the music track. The intersection of a colored gem or colored gem combination with the fixed horizontal bar is an instructive cue. The instructive cue indicates that the strum bar on the video game controller should be actuated, and the fret buttons corresponding to the colored gem or gem combination should be depressed during the strum bar actuation for users to be compliant with video game instructions.

An additional instructive cue, in the form of a white bar 509, which may be shown as raised or rising above the note track, also appears on the music track. The white bar, which may be of different colors or forms, may extend completely across or substantially across the note track. The white bar corresponds to an open note. Therefore, an open note is to be played on the guitar shaped video game controller when the raised white bar crosses or intersects the fixed horizontal bar for compliance with video game instructions. As has been described, an open note may be performed by activating the strum bar input on the guitar shaped video game controller without depression of any of the fret buttons at the time of the strum activation. While the open note is represented by a raised white bar in the embodiment of FIG. 5, other embodiments of the invention may include other visual representations of the open note in the context of video game play. The open note may be represented by, for example, an “OPEN” or “E Note” notation on the music track, or for example, a series of hollow or uncolored gems displayed across the music track, or by some other instructive cue.

A variety of user feedback displays, providing different types of feedback to users based on the users' level of compliance with video game instructions, appears in the embodiment of FIG. 5. To the left of the music track is a user score display 511 and a score multiplier display 513. A user score and score multiplier may be adjusted based on user compliance with an open note instructive cue. To the right of the music track is a user power meter 515 and a star power meter 517. Like the user score and score multiplier, the user power meter and star power meter may be adjusted based on user compliance with open note instructive cues. The adjustment of these user feedback displays is dependent on the configuration of the music rhythm video game.

The invention therefore provides for an open note input in, for example, a music rhythm video game. Although the invention has been described with respect to certain embodiments, it should be recognized that the invention may be practiced other than as specifically described, the invention comprising the claims and their insubstantial variations supported by this disclosure.

What is claimed is:

1. A method for processing an unfretted input in a music rhythm video game, comprising:
presenting an instructive cue, the instructive cue instructing a user of a video game controller to generate input signals using a video game controller associated with an unfretted input;
receiving a strum input signal generated from the video game controller;
receiving an indication that no fret buttons of a plurality of fret buttons on the video game controller were activated when the strum input signal was generated;
determining compliance with the instructive cue if the strum input signal and indication are received within a predetermined window of time after the instructive cue is presented.

2. The method of claim 1, wherein the instructive cue is presented to the user as a visual instructive cue on a display.

3. The method of claim 2, wherein the instructive cue appears as a symbol on the display about a particular location.

4. The method of claim 3, wherein the symbol moves across the display to the particular location.

5. The method of claim 4, wherein the display includes further symbols moving across predefined portions of the display, the predefined portions of the display forming a note track, some of the symbols providing further instructive cues to the user for generation of input signals using the video game controller of fretted inputs.

6. The method of claim 5, wherein the symbol moves along the note track.

7. The method of claim 5 wherein the symbol moves along a portion of the display adjacent the note track.

8. The method of claim 1, wherein the video game controller is a guitar shaped video game controller.

9. The method of claim 1, wherein the indication is an input signal generated by the video game controller indicating that no fret buttons were activated when the strum input signal was generated.

10. The method of claim 1, wherein receiving an indication that no fret buttons of a plurality of fret buttons on the video game controller were activated when the strum input signal was generated comprises receiving status information of each of the plurality of fret buttons from the video game controller and determining from the status information that none of the fret buttons was activated when the strum input signal was generated.

11. The method of claim 1, further comprising providing a first set of audio and video feedback outputs if compliance with the instructive cue is determined, and providing a second set of audio and video feedback outputs if non-compliance with the instructive cue is determined.

12. A system for providing game play instructions to a user for a music rhythm video game, comprising:
a display;
at least one video game controller including a strum input and a plurality of fret buttons; and
a processor configured by program instructions to generate a visual user interface including game play instructions, the visual user interface comprising:
a scrolling music track;
a plurality of symbols on the scrolling music track, the symbols providing instructive cues instructing the user to activate the strum input while depressing a combination of fret buttons of the plurality of fret buttons; and
a further symbol providing further instructive cues instructing the user to activate the strum input without depressing any of the plurality of fret buttons.

13. The system of claim 12, wherein the further symbol is a bar extending horizontally across the scrolling music track, the further symbol providing the further instructive cues when the symbol is about a predefined portion of the display.

14. The system of claim 12, wherein the further symbol is text displayed on the scrolling music track.

15. The system of claim 12, wherein the further symbol is a row of gems arranged horizontally across the scrolling music track.

16. The system of claim 12, wherein the visual user interface further comprises a plurality of user feedback displays, the user feedback displays providing positive feedback when the user complies with game play instructions and providing negative feedback when the user does not comply with game play instructions.
